(19) United States
(12) Patent Application Publication
(10) Pub. No.: US 2007/0095343 A1
(43) Pub. Date: May 3, 2007

(54) Diving mask

(76) Inventor: Peter Feng, Taipei (TW)

Correspondence Address: PRO-TECHTOR INTERNATIONAL SERVICES, 20775 NORADA CT., SARATOGA, CA, 95070, US

(21) Appl. No.: 11/264,931

(22) Filed: Nov. 1, 2005

(51) Int. Cl. A62B 18/02

(52) U.S. Cl. 128/201.18; 128/201.27

(57) ABSTRACT

A diving mask includes primarily at least one draining guide protruded outward which is located at a proper position of pressure equalizers protruded inward in a nosepiece of the diving mask. The draining guide is connected to a mirror and nasal wings of the nosepiece, which forms the pressure equalizers with draining guides. In addition to facilitate to use fingers to pinch nostrils to balance ear pressure with the pressure equalizers, when water permeates into the mirror, the water in the mirror can be smoothly drained into a bottom of the nosepiece through the draining guides. Therefore, a diver can lift up the bottom of diving mask under the water and then blow hard with a nose to completely expel out the water.

### BACKGROUND OF THE INVENTION

a) Field of the Invention

The present invention relates to a diving mask, and more particularly to a diving mask wherein at least one draining guide protruded outward is located at a proper position of a bottom of pressure equalizers protruded inward in a nosepiece of the diving mask. In addition to equalize ear pressure, the pressure equalizers of the draining guides can also drain the permeated water in the mirror into a bottom of the nosepiece to completely expel out the permeated water, thereby avoiding the water to be remained in the mirror of mask, and causing an insufficient vision to the diver.

b) Description of the Prior Art

Referring to FIG. 1, a conventional diving mask 100 is composed of a frame 101, a mask 102, and a mirror 103, wherein a ring of skirt 1021 is surrounding a periphery of the silicon mask 102 to fit over a face of a diver, and a nosepiece 1022 is protruded out from a center to cover on a nose of the diver. Pressure equalizers 1023 protruded inward are located at two sides of the nosepiece 1022 respectively. The pressure equalizers 1023 are located at nasal wings of the diver, so that the diver can put fingers into outsides of the pressure equalizers 1023 and pinch the nostrils for equalizing ear pressure under water. However, due to factors such as water pressure and a facial shape of a wearer, etc, sea water will usually permeate into the mask 100 and mostly stay in the nosepiece 1022 and a bottom of the mirror 103. Therefore, to expel out the permeated water in the mask 100, the diver must lift up the bottom of mask 100 to leave a gap, and to blow hard with the nose to expel the permeated water. In a practical operation, the permeated water in the nosepiece 1022 of the mask 100 is easier to be expelled, whereas the permeated water at the bottom of the mirror 103 cannot smoothly flow into the nosepiece 1022 by a separation of the pressure equalizers 1023 protruded inward, thereby not easily to be expelled. As the sea water which remains in the mirror 103 will affect a vision of the diver, it has always been troubling the diver.

### SUMMARY OF THE INVENTION

The primary object of the present invention is to install at least one draining guide protruded outward at a proper position of a bottom of pressure equalizers protruded inward in a nosepiece of the diving mask, wherein in addition to equalize ear pressure, the pressure equalizers of the draining guides can also smoothly drain the permeated water in the mirror into a bottom of the nosepiece to completely expel out the sea water permeated into the diving mask, thereby avoiding the water to be remained in the mirror of mask, and causing a trouble to the diver.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional product.

FIG. 2 shows a perspective view of the present invention.

FIG. 3 shows a perspective view of compartments of a draining device of the present invention.

FIG. 4 shows a cutaway view of a draining device of the present invention.

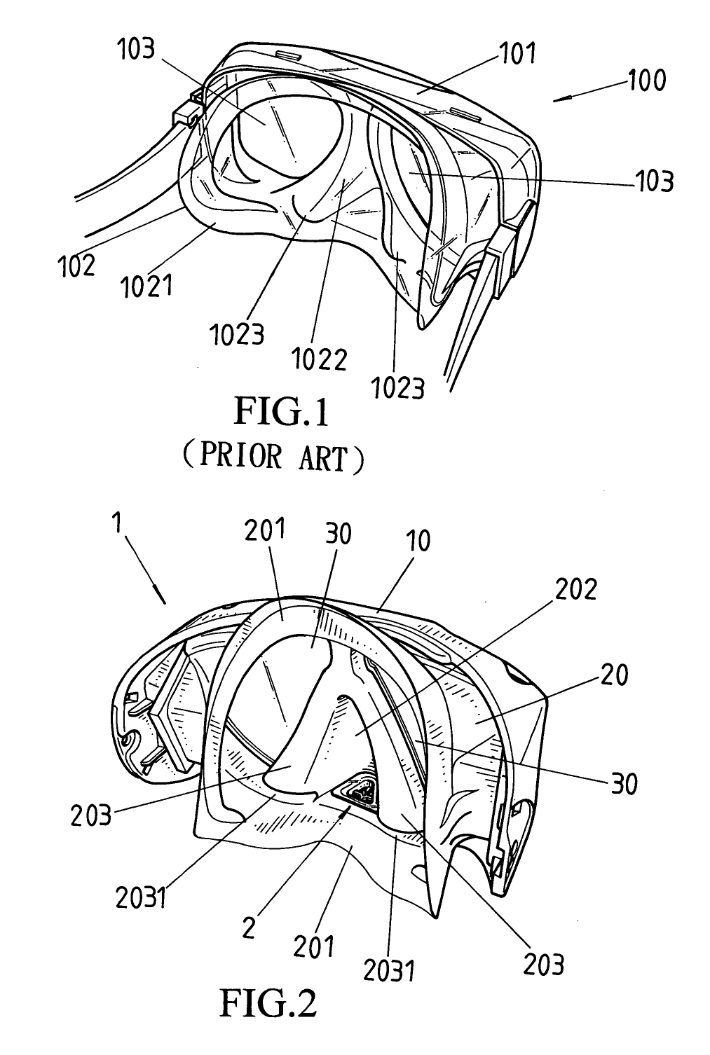

### DETAILED DESCRIPTION OF THE PREFERRED EMBODIMENTS

Referring to FIG. 2, a diving mask 1 of the present invention comprises primarily a frame 10 made of a hard material, a mask 20 made of a soft material, and a mirror 30, wherein a ring of skirt 201 is surrounding a periphery of the silicon mask 20 to fit over a face of a diver, and two pressure equalizers 203 protruded inward are located at two sides of a nosepiece 202 which is protruded outward in a center. The diver can put fingers into outsides of the pressure equalizers 203 and pinch the nostrils to equalize ear pressure under water.

At least one draining guide 2031 which is protruded outward is located at a proper position of the pressure equalizers 203 protruded inward in the nosepiece 202 of the mask 20, and is connected to the mirror 30 and nasal wings of the nosepiece 202. When water permeates into the diving mask 1, the draining guide 2031 can smoothly drain the water in the mirror 30 into a bottom of the nosepiece 202, such that the diver can lift up the bottom of diving mask 1 under the water and blow with the nose to completely expel out the permeated water, thereby accurately solving a problem which always troubles the diver during a process of operation.

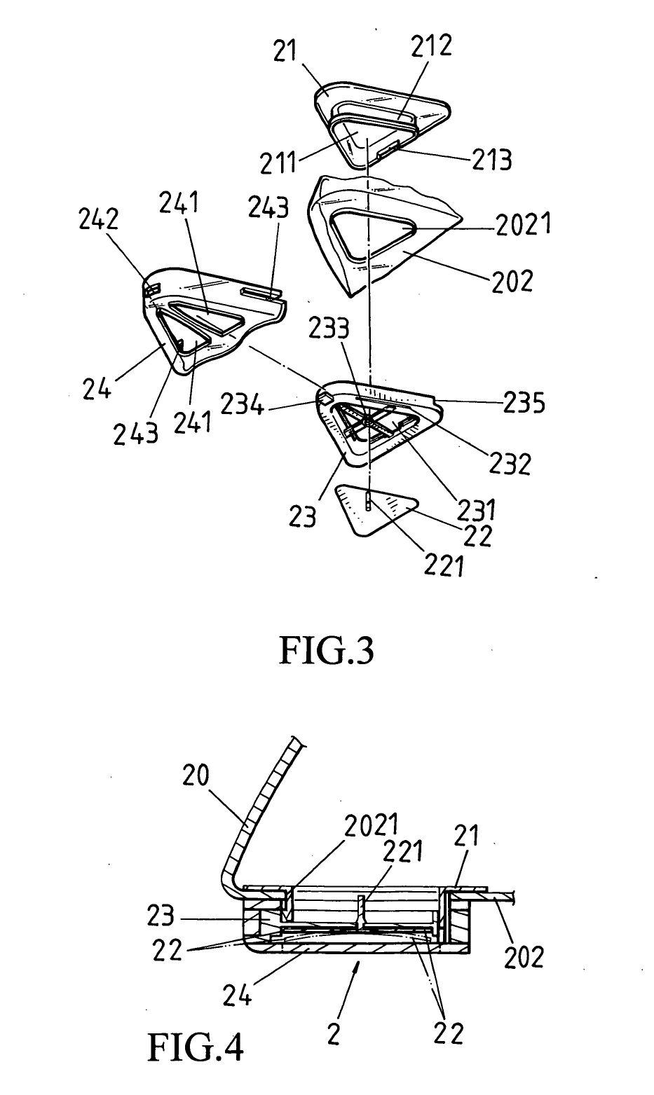

Referring to FIG. 2, FIG. 3 and FIG. 4, a one-way draining device 2 is located on a hole 2021 at a bottom of the nosepiece 202 of the mask 20. The draining device 2 is composed of an inner seat 21, a valve sheet 22, an outer seat 23, and a cap 24, wherein a seat hole 211 which is in a same shape with the hole 2021 of the nosepiece 202 is located at a center of the inner seat 21, a ring of U-shape latch groove 212 is surrounding a periphery of the seat hole 211, and a latch hole 213 is located at one end of the seat hole 211. Accordingly, the inner seat 21 is latched on the hole 2021 of the nosepiece 202 with the latch groove 212 from an inner side to an outer side. A latch pin 221 is located at a center of the soft valve sheet 22, and can be extended into a latch hole 233 in a center of the outer seat 23 for positioning. The valve sheet 22 can cover a seat hole 231 of the outer seat 23, which forms a one-way valve that can expel water in one side, from an inner side to an outer side. A transversal latch bar 232 is located at an inner rim of the seat hole 231 of the outer seat 23, such that the outer seat 23 can be latched into the latch groove 212 of inner seat 21 with the latch bar 232. A positioning pin 234 is located at one end of the triangular outer seat 23, and two hook grooves 235 are located the other two ends, respectively. A draining hole 241 is located on the triangular cap 24 which is in the same shape as the outer seat 23. A pin hole 242 is located at one end of the cap 24 having a U-shape opening, and two hooks 243 are located at the other two ends, respectively. When the cap 24 slides on the aforementioned outer seat 23, the two hooks 243 of the cap 24 are respectively hooked into the hook grooves 235 of the outer seat 23 for positioning, and the pin hole 242 of the cap 24 is used to provide for an insertion of the positioning pin 234 of the outer seat 23. Accordingly, the one-way draining device 2 of the present invention is assembled, such that the exterior seat water cannot enter into the diving mask 1 from an outside of the valve sheet 22, and a user can blow to smoothly expel out the water from the one-way valve sheet 22 when the sea water permeates into the diving mask 1.

Accordingly, at least one draining guide protruded outward which is located at a proper position of the pressure equalizers protruded inward in the nosepiece of the diving mask is used in the present invention. In addition to equalize ear pressure with the pressure equalizers, when water permeates into the diving mask of a diver, the draining guide can drain the permeated water in the mirror into the bottom of nosepiece, to facilitate a complete expelling, thereby avoiding the water remained in the mirror to cause a trouble to the diver.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A diving mask comprising a frame, a mask, and a mirror, wherein a ring of skirt is surrounding a periphery of the mask for fitting over a face of a diver, and pressure equalizers protruded inward are located at two sides of a nosepiece protruded outward in a center of the mask; at least one draining guide protruded outward being located at a proper position of the pressure equalizers which are protruded inward in the nosepiece of mask, and the draining guide being connected to the mirror and nasal wings of the nosepiece; the draining guide being able to smoothly drain the permeated water in the mirror into a bottom of the nosepiece for providing the diver to lift up the bottom of the diving mask and to blow with the nose to expel out the water, when the water permeates into the diving mask.

2. The diving mask according to claim 1, wherein a one-way draining device is located in a hole at a bottom of the nosepiece of the mask; the draining device including an inner seat, whose center is provided with a seat hole, whose periphery is provided with a ring of latch groove, and whose one end is provided with a latch hole; an outer seat, whose center is provided with a seat hole, whose inner rim is provided with a latch bar which can be latched into the latch groove of the inner seat, whose center is provided with a latch hole, whose one end is provided with a positioning pin, and whose other two ends are provided with hook grooves respectively; a valve sheet, whose center is provided with a latch pin which can be latched into the latch hole of the outer seat; a cap, whose top is provided with a draining hole, whose one end is provided with a pin hole for providing an insertion of the positioning pin of the outer seat, and whose other two ends are provided with two hooks respectively, which can be latched into hook grooves of the outer seat for positioning.
